(19) United States
(12) Patent Application Publication
(10) Pub. No.: US 2024/0387128 A1
(43) Pub. Date: Nov. 21, 2024

(54) INCLINED CONTACTOR MOUNTING

(71) Applicant: VISTEON GLOBAL TECHNOLOGIES, INC., Van Buren Township, MI (US)

(72) Inventor: Weiping Zhao, Van Buren Township, MI (US)

(73) Assignee: VISTEON GLOBAL TECHNOLOGIES, INC., Van Buren Township, MI (US)

(21) Appl. No.: 18/666,223

(22) Filed: May 16, 2024

Related U.S. Application Data
(60) Provisional application No. 63/502,458, filed on May 16, 2023.
(60) Provisional application No. 63/508,800, filed on Jun. 16, 2023.

(51) Int. Cl. H01H 45/04

(52) U.S. Cl. CPC H01H 45/04

(57) ABSTRACT

An electrical relay system having an inclined contactor mounting. The system may include a housing including a first circuit and a second circuit. A relay may be disposed within the housing and configured for moving a contactor between a closed position and an opened position to respectively connect and disconnect the first and second circuits. The contactor may be inclined relative to a vertical axis or any specified axis such that the contactor moves in an oblique manner relative to the vertical axis or any specified axis.

### CROSS-REFERENCE TO RELATED APPLICATIONS

This application claims the benefit of U.S. Provisional Application No. 63/502,458, filed May 16, 2023, and U.S. Provisional Application No. 63/508,800, filed Jun. 16, 2023, the disclosures of which are hereby incorporated by reference in their entireties herein.

### INTRODUCTION

The present disclosure relates to electrical relays having inclined contactor mounting, such as but not necessarily limited to electrical relays of the type having movable contactors configured for facilitating high powered, electrical connections between circuits within a junction box or other device.

An electrical relay of the type commonly employed in a junction box, battery control module, battery disconnect unit, or other device may include a contactor assembly configured for moving between closed and opened positions, such as to respectively connect and disconnect two or more circuits. The electrical relay may be required to operate according to a wide range of requirements that may vary depending on the use, application, environment, or other factors accompanying the device, circuits, etc. associated therewith. In the case of electrical relays employed within electric vehicles or other vehicles having low and/or high-powered circuits in need of being selectively connected and disconnected, the relay be required to operate according to design and/or specification requirements. The Society of Auto Automotive Engineers (SAE) and the International Organization for Standardization (ISO), for example, have developed standards or compliance requirements for environmental performance testing of electronic equipment, which may include vibration, shock, and/or load testing criteria to ensure that electronic components may withstand the forces expected to be encountered during vehicle operation, e.g., see SAE J1378 and/or ISO 16750-3. While not intended to be limited to a specific standard, specification, or the like, the present disclosure contemplates a need for the electrical relay to meet crash, shock, or vibration requirements and/or to operate properly when subjected to differing loading conditions. The need for the electrical relay to comply with design, standard, or other requirements may require the electrical relay to be constructed such that electrical relay may require stronger, larger, or more expensive materials, components, construction, design, etc. when faced with meeting higher or more stringent requirements which increase cost, size, weight, and etc.

### SUMMARY

One aspect of the present disclosure relates to an electrical relay capable of meeting higher or more stringed crash, vibration, shock, load, or other operational requirements in a manner that minimizes or limits attendant increases in materials, components, construction, design, etc. This may be done with the relay being configured within an inclined contactor, contactor assembly, or other componentry capable of enabling a moveable contactor to move between engaged and disengaged positions relative to an actuation axis (relay shaft axis) inclined, tilted, or otherwise oblique to any axis, for simplifying description, use a vertical axis of an associated junction box, battery control module, battery disconnect unit, vehicle, or another device. This oblique movement or manner of movement relative to the vertical axis may be beneficial in complying with higher or more stringed crash, shock, vibration, load, or other operational requirements and/or to provide a more robust configuration in a manner that minimizes or limits attendant increases in materials, components, construction, design, etc. The improved performance and/or compliance may result from the oblique movement transferring, deflecting, or minimizing forces imparted along the vertical axis away from or limiting the influence thereof on the contactor and/or other components of the electrical relay, which may in turn permit the electrical relay to meet greater crash, vibration, shock, load, or other operational requirements than if the contactors, etc. were operated according to an actuation axis that parallels the vertical axis.

One aspect of the present disclosure relates to an electrical relay system for a vehicle. The electrical relay system may include a housing including a first circuit and a second circuit and a relay disposed within the housing and configured for moving between an opened position and a closed position, optionally with the closed position electrically connecting the first circuit with the second circuit and the opened position electrically disconnecting the first circuit from the second circuit. The relay may include a contactor assembly having first and second fixed contactors and a moveable contactor, a shaft assembly having a contact spring, a linear shaft, a return spring, a moving core, and a fixed core, a coil assembly having a coil and a bobbin, and a shaft assembly having a yoke and a yoke ring. A centerline of the relay defined along an actuation axis of the linear shaft may be inclined at an inclination angle relative to a vertical axis of the vehicle, optionally with the inclination angle being less than 90 degrees such that the linear shaft moves in an oblique manner relative to the vertical axis.

The electrical relay system may include a mounting bracket connected between the housing and the relay, optionally with the mounting bracket being configured to incline the relay according to the inclination angle.

The electrical relay system may include the mounting bracket configured to orientate a bottom surface of the relay to be perpendicular to the actuation axis.

The electrical relay system may include the mounting bracket attached to the bottom surface of the relay.

The electrical relay system may include the mounting bracket being wedge shaped, optionally with a vertical surface, a horizontal surface, and an inclined surface extending between the vertical and horizontal surfaces and the mounting bracket orientating the bottom surface to be parallel with the inclined surface.

The electrical relay system may include a bottom surface area of the bottom surface matching an inclined surface area of the inclined surface.

The electrical relay system may include the mounting bracket including a fastener and/or an adhesive to secure the bottom surface to the inclined surface.

The electrical relay system may include the mounting bracket attaching between a side of the housing and a side of the relay, optionally with the side of the housing is parallel with the vertical axis.

The electrical relay system may include a mounting bracket connected between the housing and a support structure and/or a device of the vehicle external to the housing, optionally with the mounting bracket is configured to incline the housing according to the inclination angle.

The electrical relay system may include the mounting bracket being wedge shaped, optionally with a vertical surface, a horizontal surface, and an inclined surface extending between the vertical and horizontal surfaces.

The electrical relay system may include a mounting bracket connected between the housing and the relay or between the housing and a support structure and/or a device of the vehicle, optionally with the mounting bracket configured to incline the housing or the relay according to the inclination angle such that the first and second fixed contactors are orientated to be parallel with or perpendicular to the actuation axis.

The electrical relay system may include the first fixed contactor connected to the first circuit, the second fixed contactor connected to the second circuit, and the moveable contactor movable along the actuation axis such that the moveable contactor engages with the first and second fixed contactors when in the closed position and disengages from the first and second fixed contactors when in the opened position.

The electrical relay system may include a mounting bracket having an inclined surface attached to the relay, optionally with the inclined surface inclining the relay within the housing according to the inclination angle.

The electrical relay system may include a mounting bracket attached to an exterior surface of the housing, wherein the mounting bracket is wedge shaped, optionally with a vertical surface, a horizontal surface, and an inclined surface extending between the vertical and horizontal surfaces and/or the inclined surface attaching in a parallel manner with the exterior surface to incline the housing according to the inclination angle.

One aspect of the present disclosure relates to an electrical relay system. The electrical relay system may include a housing including a first circuit and a second circuit, optionally with the housing shaped to include a vertical axis, a longitudinal axis, and a lateral axis, with the vertical axis perpendicular to the longitudinal axis perpendicular and the lateral axis. The electrical relay system may include a relay disposed within the housing and configured for moving between an opened position and a closed position, optionally with the closed position electrically connecting the first circuit with the second circuit, the opened position electrically disconnecting the first circuit from the second circuit. The relay may include a first fixed contactor connected to the first circuit, a second fixed contactor connected to the second circuit, and a moveable contactor operable between an engaged position and a disengaged positioned, optionally with the engaged position resulting from the moveable contactor engaging with the first and second fixed contactors to establish an electrical connection therebetween when the relay is in the closed position and the disengaged position resulting from the moveable contactor disengaging from the first and second fixed contactors to disconnect the electrical connection when the relay is in the opened position. The electrical relay system may include a mounting element connected between the housing and the relay, optionally with the mounting element configured to incline the relay relative to the vertical axis such that an actuation axis of the moveable contact follows an inclination angle oblique to the vertical axis.

The electrical relay system may include the mounting element being wedge shaped, optionally with a vertical surface, a horizontal surface, and an inclined surface extending between the vertical and horizontal surfaces and/or the mounting element attaches to a bottom surface or a side surface of the relay.

The electrical relay system may include the mounting element attached between a side of the housing and a side of the relay, optionally with the side of the housing is parallel with the vertical axis.

The electrical relay system accord may include the inclination angle being less than 90 degrees from the vertical axis.

One aspect of the present disclosure relates to an electrical relay system for a vehicle. The electrical relay system may include a housing having a first circuit and a second circuit and a plurality of relays disposed within the housing and configured for moving between an opened position and a closed position. The relays may each include a first fixed contactor, a second fixed contactor, and a moveable contactor operable between an engaged position and a disengaged positioned, optionally with the engaged position resulting from the moveable contactor engaging with the first and second fixed contactors to establish an electrical connection therebetween when the relay is in the closed position and the disengaged position resulting from the moveable contactor disengaging from the first and second fixed contactors to disconnect the electrical connection when the relay is in the opened position. The electrical relay system may include a mounting element connected between the housing and the vehicle, optionally with the mounting element is configured to incline the housing relative to a vertical axis of the vehicle such that an actuation axis of each of the moveable contacts follows an inclination angle oblique to the vertical axis.

The electrical relay system may include a mounting bracket attached to an exterior surface of the housing and a support structure of the vehicle, wherein the mounting bracket is wedge shaped, optionally with a vertical surface, a horizontal surface, and an inclined surface extending between the vertical and horizontal surfaces, wherein the inclined surface attaches to the exterior surface to incline the housing according to the inclination angle.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a schematic diagram of an electrical system in accordance with one aspect of the present disclosure.

FIG. 2 illustrates a schematic diagram of a power switch system having one or more relays with inclined contactor mounting in accordance with one aspect of the present disclosure.

FIG. 3 illustrates a cross-sectional, schematic diagram of a relay in an opened position in accordance with one aspect of the present disclosure.

FIG. 4 illustrates a cross-sectional, schematic diagram of a relay in a closed position in accordance with one aspect of the present disclosure.

FIG. 5 diagrammatically represents forces on an inclined relay in accordance with one aspect of the present disclosure.

FIG. 6 illustrates a schematic, cross-sectional view of a junction box in accordance with one aspect of the present disclosure.

FIG. 7 illustrates a schematic diagram of the mounting bracket having a wedge shape in accordance with one aspect of the present disclosure.

FIG. 8 illustrates a schematic diagram of the wedge-shaped mounting bracket supporting multiple relays in accordance with one aspect of the present disclosure.

FIG. 9 illustrates a schematic diagram of the wedge-shaped mounting bracket supporting multiple relays in accordance with one aspect of the present disclosure.

FIG. 10 illustrates a schematic diagram of the junction box being inclined in accordance with one aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

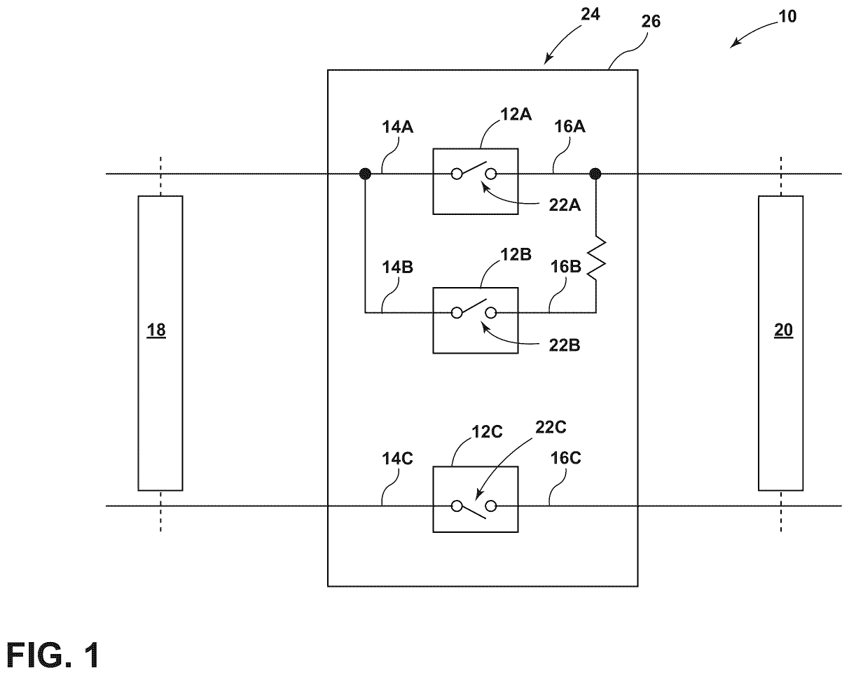

FIG. 1 illustrates a schematic diagram of an electrical system 10 in accordance with one aspect of the present disclosure. The system 10 is intended to be exemplary of a wide variety of electrical systems, networks, circuit connections, etc. whereby one or more relays 12A, 12B, 12C may be employed for selectively connecting and disconnecting two or more circuit connections 14A, 14B, 14C, 16A, 16B, 16C, which for presentation simplicity are reference generically as 12, 14, 16. The circuit connections 14,16 are shown for non-limiting purposes to correspond with high-powered circuits utilized for facilitating electrical connections between an energy source 18 and a load 20. If employed with a vehicle, for example, the energy source 18 may correspond with a battery, a rechargeable energy storage system (RESS), or other power source utilized to facilitate electrically powering a high voltage (HV) bus, such as one connected to an electric motor used for propulsion or other load 20. The relays 12 may include a contactor 22A, 22B, 22C mounted in an inclined orientation and configured for selectively connecting and disconnecting the circuit connections 14,16. The contactors 22 may be inclined to maximize compliance with operating requirements while minimizing or limiting the use of stronger, larger, or more expensive materials, components, construction, design, etc. The relays 12 may be included as part of a junction box, battery control module, battery disconnect unit, or other device 24, such as within a housing 26 thereof, which may include additional components, circuitry, etc. to facilitate various operations and processes. While predominantly described with respect to the relays 12 being included within a vehicle, one skilled in the art would appreciate the relays 12, or more specifically the inclined contactor mounting described herein, being advantageous in applications outside of a vehicle.

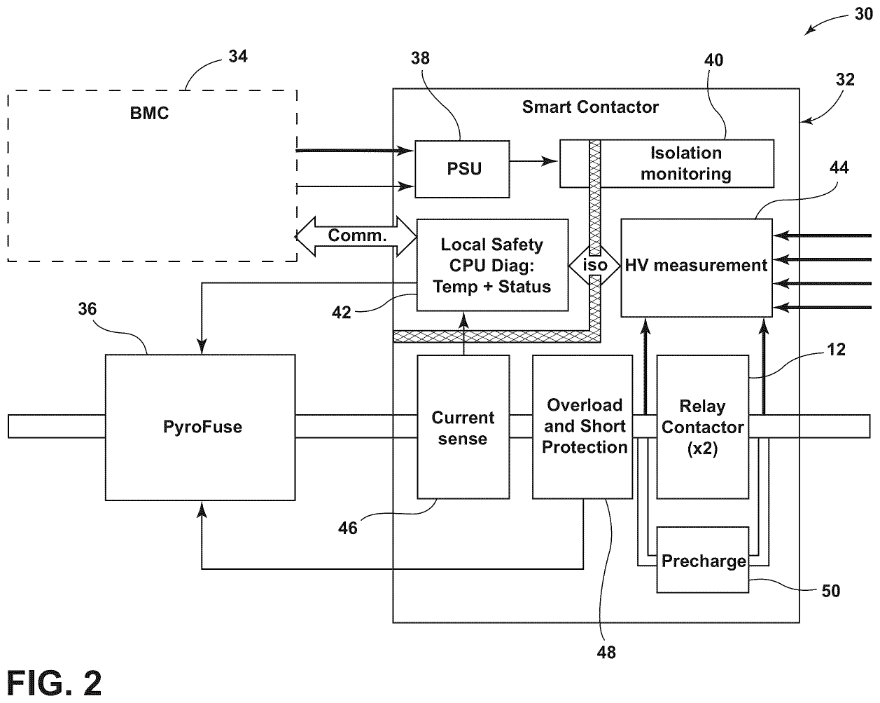

FIG. 2 illustrates a schematic diagram of a power switch system 30 having one or more relays 12 with inclined contactor mounting in accordance with one aspect of the present disclosure. The power switch system 30 may be configured for use within a vehicle to facilitate selectively establishing electrical connections. One non-limiting aspect of the present disclosure contemplates system including a smart contactor system 32 whereby one or more relays 12 having inclined contactors 22 may be included to facilitate making electrical connections and disconnections. The smart contactor system 32 may be employed to provide a reliable, high voltage high power switch capable of meeting tight requirements for volume and weight. The system 30 may be integrated to support multiple features and perform multiple functions, optionally without having to rely upon external components, including but not limited to capabilities for current and voltage measurement, temperature measurement, communications, fuses control, and other related features useful within vehicles for selectively connecting high voltage power sources (e.g., batteries) with consuming units (e.g., electric motors). The system 30 may be operable with a battery management controller (BMC) 34 and/or a pyrofuse 36. The smart contactor system 32, BMC and/or pyrofuse 34, 36 are shown for non-limiting purposes as being standalone devices or components, however, the present disclosure fully contemplates including the BMC 34 and/or the pyrofuse 36 within the smart contactor system 32, i.e., to integrate those components with the integrated components of the smart contactor system 32. The smart contactor system 32 may include a power supply unit (PSU) 38, an isolation monitoring module 40, a local safety central processing unit (CPU) 42 operable for measuring, sensing, or otherwise calculate temperature and/or status, a high voltage (HV) measurement module 44, a current sensing module 46, an overloaded short protection module 48, one or more relays 12 with inclined contactors 22 capable of being transition between open and close states, and/or a precharge module 50, optionally with each integrated within a common housing 26.

The smart contactor system 32 may be configured in the manner described in U.S. provisional application Ser. No. 63/502,458, filed May 16, 2023, and entitled Integrated Smart High Voltage Battery Disconnect Unit, the disclosure of which is hereby incorporated by reference in its entirety herein. The smart contactor system 32 may be configured to operate as a junction box and/or another type of battery disconnect unit (BDU), optionally with the BMC and/or pyrofuse additionally been integrated therewith. The power switch system 30 may be configured for providing high performance (power density, packaging, reliability, etc.) at a relatively lower cost due to the integrated componentry. The power switch system may include multiple discrete devices, including a contactor, pyrofuse driver, current sensor, voltage sensors, temperature sensors, isolation detection, diagnostic, crash signal reaction circuit, and/or a precharge circuit. The integration in a single device may provide multiple improvements and benefits, including space saving (more compact), weight saving, simplifying part handling during manufacturing (more compact, more robust, less connections needed), increased robustness and reliability (less connections prone to failure), increased accuracy of measurements (sensors can be closer to measurement points, shorter connection lines generate less noise), and/or faster reaction time (less connections, smaller capacities, shorter connections lines).

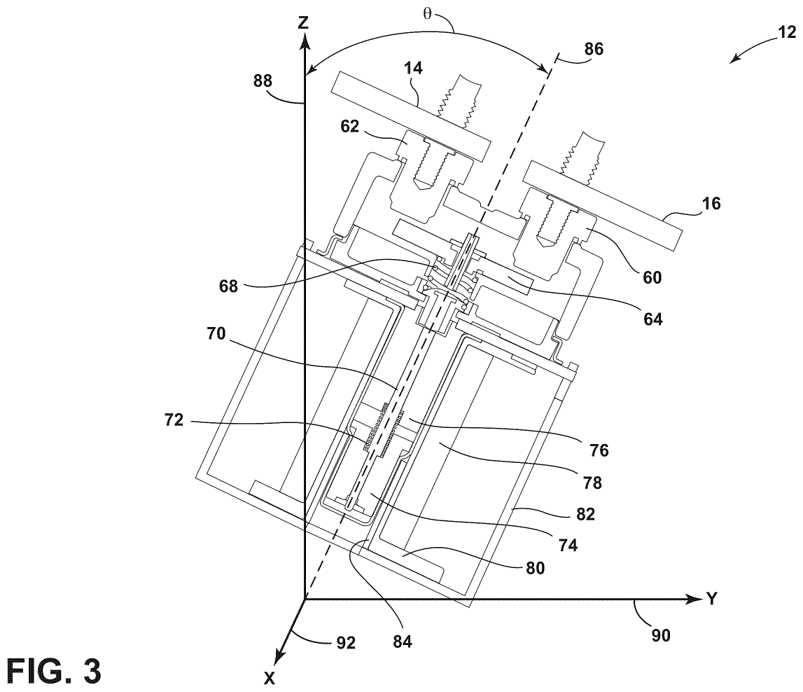

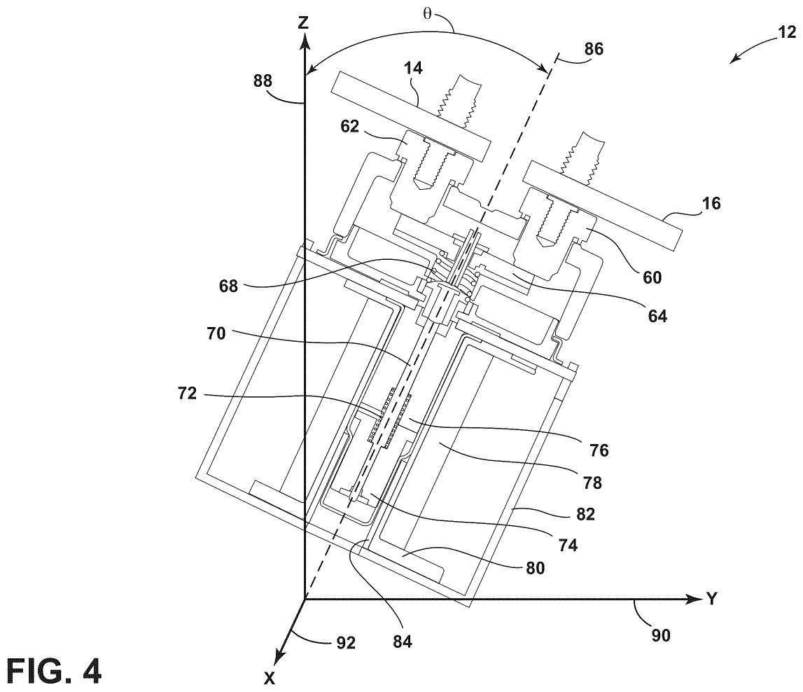

FIGS. 3 and 4 illustrate cross-sectional, schematic diagrams of a relay 12 having inclined contactor mounting in accordance with one aspect of the present disclosure. FIG. 3 illustrates the relay 12 in an open or disengaged position, and FIG. 4 illustrates the relay 12 in an closed or engaged position. The relay 12 may be disposed within the housing 26 of the junction box 24 and configured for moving between the opened and closed positions. The closed position may correspond with electrically connecting the first circuit 14 with the second circuit 16 and the opened position may correspond with electrically disconnecting the first circuit 14 from the second circuit 16. The relay 12 may include a contactor assembly having first and second fixed contactors 60, 62 and a moveable contactor 64, a shaft assembly having a contact spring 68, a linear shaft 70, a return spring 72, a moving core 74, and a fixed core 76, a coil assembly having a coil 78 and a bobbin 80, and a shaft assembly having a yoke 82 and a yoke ring 84. While shown in the illustrated manner, the relay 12 may include more or less components and/or be configured differently while providing inclined contactor mounting. A controller or other device (not shown) may be operable with the relay 12 to facilitate selectively energizing the coil 78 to facilitate moving the linear shaft 70 along an actuation axis 86 such that the moveable contactor 64 may be actuated between an engaged position (FIG. 4) and a disengaged position (FIG. 3). The engaged position may result from the moveable contactor 64 engaging with the first and second fixed contactors 60, 62 to establish an electrical connection therebetween when the relay 12 is in the closed position. The disengaged position may result from the moveable contactor 64 disengaging from the first and second fixed contactors 60, 62 to disconnect the electrical connection when the relay 12 is in the opened position.

A centerline of the relay 12 defined along the actuation axis 86 of the linear shaft 70 may be inclined at an inclination angle θ relative to a vertical axis (Z-direction) 88 of the vehicle or the junction box 24 having the relay 12. The vertical axis 88 may be perpendicular to a longitudinal axis (Y-direction) 90 and a lateral axis (X-direction) 92, which may in turn be perpendicular to each other, optionally with the longitudinal axis 90 corresponding with a length and the horizontal axis 92 corresponding with a width of a vehicle. The inclination angle θ may be less than 90 degrees such that the linear shaft 70 moves in an oblique manner relative to the vertical axis 88. The relay 12 may be configured in the illustrated manner to meet higher or more stringed crash, vibration, shock, load, or other operational requirements in a manner that minimizes or limits attendant increases in materials, components, construction, design, etc. This may be accomplished due to the relay 12 being inclined such that the moveable components move relative to the actuation axis 86, which is inclined, tilted, or otherwise oblique to the vertical axis 88 of the junction box and/or due to the junction box also being oblique to the vehicle or other device. This oblique movement or manner of actuation relative to the vertical axis 88 may be beneficial in improving performance and/or compliance as a result of the oblique movement transferring, deflecting, or minimizing forces imparted along the vertical axis 88 away from or limiting the influence thereof on the moveable contactor 64 and/or other components of the electrical relay 12, which may in turn permit the electrical relay 12 to meet greater crash, vibration, shock, load, or other operational requirements than if the moveable contactors 64, etc. were operated according to another actuation axis that parallels the vertical axis 88. The inclination angle θ can be between actuation axis 86 and axis X 92, or axis Y 90, respectively, above descriptions for the inclination angle θ between actuation axis 86 and axis Z 86 are applied to these 2 situations, but no necessary to repeat.

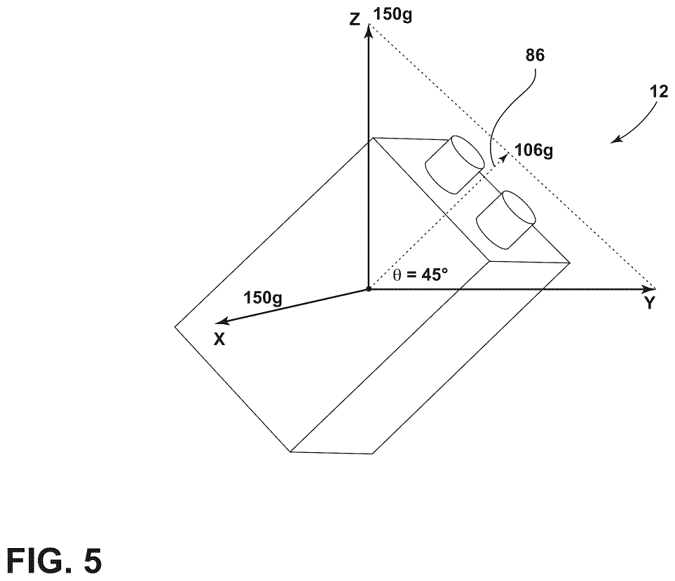

By way of example, FIG. 5 diagrammatically represents the inclination of the relay 12, which is shown as a generic block, resulting in less force being applied along the actuation axis 86 than if the actuation axis 86 were aligned with the vertical axis 88 (Z-direction). The relay 12 may be inclinedly mounted in X-Y plane, X-Z plan, or Y-Z plane such that the mechanical shock (acceleration impact) to the relay 12 may be defined along +/−X, +/−Y, +/−Z directions, respectively. In an electric vehicle (EV) battery pack of a vehicle or other device, for example, the relay 12 may be subjected to 60 g, 90 g, 150 g, or even larger shock zones. To pass operational requirements at these and other higher mechanical shocks, a return spring force could be increased, however, such an increase would also include increasing the coil power and lead to higher energy consumption and larger components. These increases may add cost, weight, and energy consumption and may limit the capability of short current and/or levitation of the moveable contact. The relay 12 contemplated herein may meet operational requirements for the higher mechanical shocks, such as 60 g, 90 g, 150 g, etc., without necessarily increasing the return spring force due to the inclined or tilted mounting. In other words, when mounted in the described manner, i.e., such that the actuation axes of the linear shaft, e.g., plunger, is inclined, which is shown to be inclined approximately 45 degrees relative to Z-direction or other direction of impact, the amount of force on the linear shaft and/or other components moving in parallel to the actuation axis 86 may be reduced in comparison to those components being aligned with or parallel to the vertical axis 88. By projecting 150 g in Z or Y direction to actuation axis 86 or direction, approximately 106 g may be applied to linear shaft direction instead of the full 150 g. The relay 12 or components thereof may be inclined at other angles besides 45 degrees, such as at greater or lesser degrees depending on the desired amount of force reduction. Accordingly, the inclination of the relay 12 and/or the junction box having the relay 12 may be useful in redirecting or redistributing mechanical shock and/or forces applied thereto relative to the moveable contactor 64 and/or the junction box being upright, flat, or otherwise non-inclined.

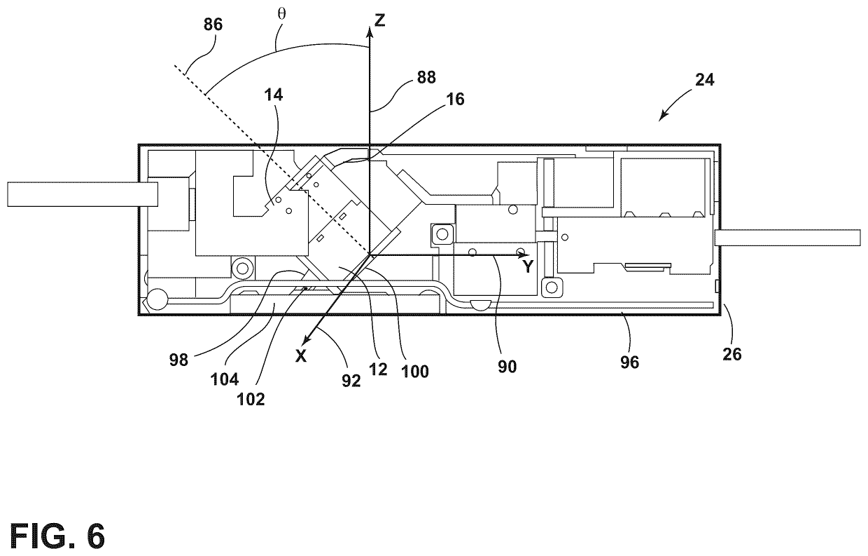

FIG. 6 illustrates a schematic, cross-sectional view of the junction box 24 in accordance with one aspect of the present disclosure. This view illustrates a portion of the junction box 24 whereby the relay 12 may be employed to connect and disconnect first and second circuit connections 14, 16. Additional components are shown and unlabeled for illustrative purposes to represent additional circuit connections 14, 16, devices, elements, etc. that may additionally be included within the junction box 24 was associated therewith. The relay 12 may be disposed within the housing 26 such that the actuation axis 86 may be inclined at the inclination angle θ relative to the vertical axis 88. The junction box 24 may be rectangular in shape or otherwise configured such that the vertical axis 88 may correspond with of be parallel to a side or a side wall of the housing 26 and/or such that the additional components may be considered to be vertically aligned or parallel with the vertical axis 88 due to those components having a generally vertical orientation in comparison to the relay 12 having an inclined orientation. One aspect of the present disclosure contemplates the junction box 24 being disposed within a vehicle in illustrated manner such that a bottom surface 96 of the junction box 24 may be parallel or coplanar with the X and Y axes 90, 92.

A mounting bracket 98 may be connected between the housing 26 and the relay 12 and configured to incline the relay 12 according to the illustrated inclination angle θ. The mounting bracket 98 may be configured to orientate a bottom surface 100 of the relay 12 to be perpendicular to the actuation axis 88. The mounting bracket 98 may include a fastener and/or adhesive 102 configured for connecting to a side 104 of the housing 26 and the side of the relay 12. The mounting bracket 98 is shown to have a singular connection to the junction box 24, however, additional connections, flanges, etc., may be additionally employed to maintain the inclination angle θ. An end or contactor portion of busbars, traces, or other connections utilized to engage the first and second fixed contactors 60, 62 may be similarly inclined and/or shape to match the inclined orientation. The illustrated mounting bracket 98 is intended to be exemplary of various braces, supports, etc. that may be used to connect the relay 12 to the housing 26, or optionally another component within the housing 26, such that the relay 12 may be retained in mounted in an inclined orientation. The relay 12 is shown to be resting against and/or proximate to the side 104 of the housing 26, however, the mounting bracket 98 and/or additional elements thereof may be sized, shaped, etc. to provide a freestanding or independent support apparatus for inclining the relay 12.

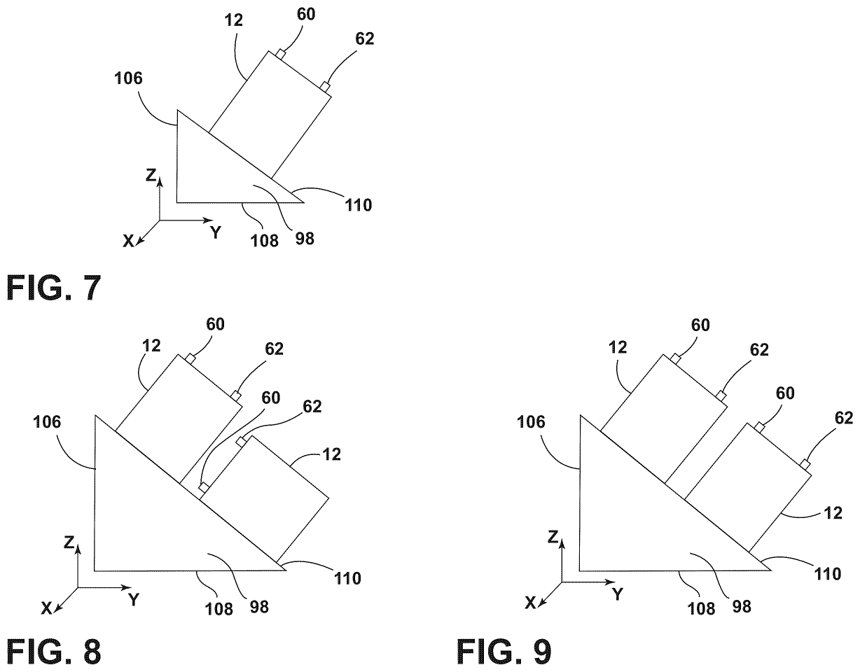

FIG. 7 illustrates a schematic diagram of the mounting bracket 98 having a wedge shape in accordance with one aspect of the present disclosure. The wedge shape may be characterized by the mounting bracket 98 including a vertical surface 106, a horizontal surface 108, and an inclined surface 110 extending therebetween. The wedge-shaped mounting bracket 98 may be formed out of a singular solid piece of material, by attaching or molding individual pieces of material together, or in another suitable manner. The wedge is shown in FIG. 7 to be configured for mounting to or supporting the bottom surface of the relay 12, optionally with the assistance of a fastener, an adhesive, and/or other attachment element (not shown). The surface area of the inclined surface 110 is shown to be larger than the surface area of the bottom surface of the relay 12, however, the mounting bracket 98 may be alternatively sized and shaped such that the two surface areas match each other or are approximately equal in size and shape. FIG. 8 illustrates a schematic diagram of the wedge-shaped mounting bracket 98 supporting multiple relays 12 in accordance with one aspect of the present disclosure, with one of the relays 12 extending way from the inclined surface 110 and the other being perpendicular thereto. FIG. 9 illustrates a schematic diagram of the wedge-shaped mounting bracket 98 supporting multiple relays 12 in accordance with one aspect of the present disclosure, with both of the relays 12 commonly extending way from the inclined surface 110. The capability to mount multiple relays 12 in different orientations along the same inclined surface 110 of the mounting bracket 98 may be advantageous in customizing or designing the junction box 24 to accommodate multiple inclined relays 12 with a minimal quantity of additional bracket 98, fasters, etc.

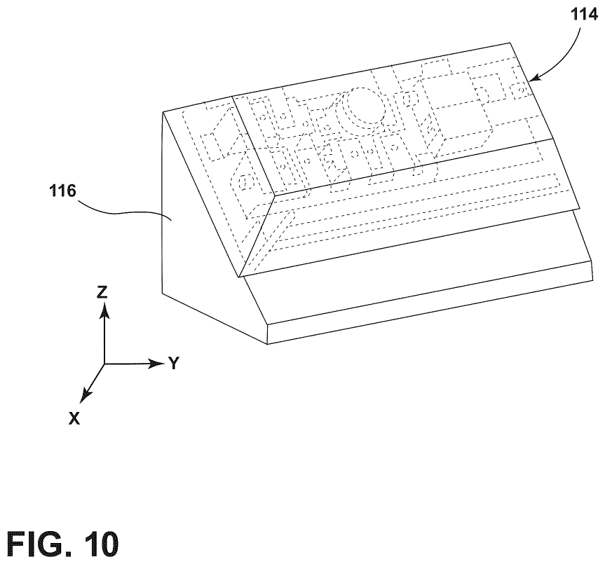

FIG. 10 illustrates a schematic diagram of a junction box 114 inclined in accordance with one aspect of the present disclosure. An external mounting bracket 116 similar to that described above, i.e., one having a wedge shape with a vertical surface, horizontal surface, and an inclined surface, may be configured to support or attached to a bottom surface of the junction box 114. The junction box 114 shown in FIG. 11 may omit an internal mounting bracket 98, i.e., instead of including the mounting bracket 98 shown in FIG. 6, the junction box 114 may be configured such that one or more relays therein are uninclined, e.g., parallel or planar with one or more of the sides of the junction box 114 and/or the vertical, longitudinal, and lateral axes of a vehicle or other device. The use of the external mounting bracket 116 may be advantageous in eliminating the need for the internal mounting bracket 98 shown above in FIG. 5-10, however, the present disclosure fully contemplates using multiple mounting brackets 98, 116, such as one or more internal mounting brackets 98 in cooperation with the mounting bracket 116 mounted externally. The external mounting bracket 116 may be beneficial as an aftermarket addition or component suitable for use with existing or previously designed junction boxes so as to effectively incline the relays 12 therein without having to redesign or alter the junction box 24 and/or to permit the components of the junction box 24 to be assembled without having to be inclined therein.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An electrical relay system for a vehicle, comprising:
a housing including a first circuit and a second circuit;
a relay disposed within the housing and configured for moving between an opened position and a closed position, the closed position electrically connecting the first circuit with the second circuit, the opened position electrically disconnecting the first circuit from the second circuit, the relay including:
a contactor assembly having first and second fixed contactors and a moveable contactor;
a shaft assembly having a contact spring, a linear shaft, a return spring, a moving core, and a fixed core;
a coil assembly having a coil and a bobbin; and
a shaft assembly having a yoke and a yoke ring; and
wherein a centerline of the relay defined along an actuation axis of the linear shaft is inclined at an inclination angle relative to a vertical axis or any specified axis of the vehicle, wherein the inclination angle is less than 90 degrees such that the linear shaft moves in an oblique manner relative to the vertical or any specified axis.

2. The electrical relay system according to claim 1, further comprising:
a mounting bracket connected between the housing and the relay, wherein the mounting bracket is configured to incline the relay according to the inclination angle.

3. The electrical relay system according to claim 2, wherein:
the mounting bracket is configured to orientate a bottom surface of the relay to be perpendicular to the actuation axis.

4. The electrical relay system according to claim 3, wherein:
the mounting bracket is attached to the bottom surface of the relay.

5. The electrical relay system according to claim 4, wherein:
the mounting bracket is wedge shaped, with a vertical surface, a horizontal surface, and an inclined surface extending between the vertical and horizontal surfaces; and
the mounting bracket orientates the bottom surface to be parallel with the inclined surface.

6. The electrical relay system according to claim 5, wherein:
a bottom surface area of the bottom surface matches an inclined surface area of the inclined surface.

7. The electrical relay system according to claim 6, wherein:
the mounting bracket includes a fastener and/or an adhesive to secure the bottom surface to the inclined surface.

8. The electrical relay system according to claim 2, wherein:
the mounting bracket is attached between a side of the housing and a side of the relay, wherein the side of the housing is parallel with the vertical axis.

9. The electrical relay system according to claim 1, further comprising:
a mounting bracket connected between the housing and a support structure and/or a device of the vehicle external to the housing, wherein the mounting bracket is configured to incline the housing according to the inclination angle.

10. The electrical relay system according to claim 9, wherein:
the mounting bracket is wedge shaped, with a vertical surface, a horizontal surface, and an inclined surface extending between the vertical and horizontal surfaces.

11. The electrical relay system according to claim 1, further comprising:
a mounting bracket connected between the housing and the relay or between the housing and a support structure and/or a device of the vehicle, wherein the mounting bracket is configured to incline the housing or the relay according to the inclination angle such that the first and second fixed contactors are orientated to be parallel with or perpendicular to the incline surface.

12. The electrical relay system according to claim 11, wherein:
the first fixed contactor is connected to the first circuit, the second fixed contactor is connected to the second circuit, and the moveable contactor is movable along the actuation axis such that the moveable contactor engages with the first and second fixed contactors when in the closed position and disengages from the first and second fixed contactors when in the opened position.

13. The electrical relay system according to claim 1, further comprising:
a mounting bracket having an inclined surface attached to the relay, the inclined surface inclining the relay within the housing according to the inclination angle.

14. The electrical relay system according to claim 1, further comprising:
a mounting bracket attached to an exterior surface of the housing, wherein the mounting bracket is wedge shaped, with a vertical surface, a horizontal surface, and an inclined surface extending between the vertical and horizontal surfaces, wherein the inclined surface attaches in a parallel manner with the exterior surface to incline the housing according to the inclination angle.

15. An electrical relay system, comprising:
a housing including a first circuit and a second circuit, the housing shaped to include a vertical axis, a longitudinal axis, and a lateral axis, with the vertical axis perpendicular to the longitudinal axis perpendicular and the lateral axis;
a relay disposed within the housing and configured for moving between an opened position and a closed position, the closed position electrically connecting the first circuit with the second circuit, the opened position electrically disconnecting the first circuit from the second circuit, the relay including:
a first fixed contactor connected to the first circuit;
a second fixed contactor connected to the second circuit; and
a moveable contactor operable between an engaged position and a disengaged positioned, the engaged position resulting from the moveable contactor engaging with the first and second fixed contactors to establish an electrical connection therebetween when the relay is in the closed position, the disengaged position resulting from the moveable contactor disengaging from the first and second fixed contactors to disconnect the electrical connection when the relay is in the opened position; and
a mounting element connected between the housing and the relay, wherein the mounting element is configured to incline the relay relative to the vertical axis such that an actuation axis of the moveable contact follows an inclination angle oblique to the vertical axis.

16. The electrical relay system according to claim 15, wherein:
the mounting element is wedge shaped, with a vertical surface, a horizontal surface, and an inclined surface extending between the vertical and horizontal surfaces; and
the mounting element attaches to a bottom surface or a side surface of the relay.

17. The electrical relay system according to claim 15, wherein:
the mounting element is attached between a side of the housing and a side of the relay, wherein the side of the housing is parallel with the vertical axis.

18. The electrical relay system according to claim 15, wherein:
the inclination angle is less than 90 degrees from the vertical axis or any specified axis.

19. An electrical relay system for a vehicle, comprising:
a housing including a first circuit and a second circuit;
a plurality of relays disposed within the housing and configured for moving between an opened position and a closed position, the relays each including:
a first fixed contactor;
a second fixed contactor; and
a moveable contactor operable between an engaged position and a disengaged positioned, the engaged position resulting from the moveable contactor engaging with the first and second fixed contactors to establish an electrical connection therebetween when the relay is in the closed position, the disengaged position resulting from the moveable contactor disengaging from the first and second fixed contactors to disconnect the electrical connection when the relay is in the opened position; and
a mounting element connected between the housing and the vehicle, wherein the mounting element is configured to incline the housing relative to a vertical axis or any specified axis of the vehicle such that an actuation axis of each of the moveable contacts follows an inclination angle oblique to the vertical axis or any specified axis.

20. The electrical relay system according to claim 19, further comprising:
a mounting bracket attached to an exterior surface of the housing and a support structure of the vehicle, wherein the mounting bracket is wedge shaped, with a vertical surface, a horizontal surface, and an inclined surface extending between the vertical and horizontal surfaces, wherein the inclined surface attaches to the exterior surface to incline the housing according to the inclination angle.
